(19) United States
(12) Patent Application Publication
(10) Pub. No.: US 2018/0060298 A1
(43) Pub. Date: Mar. 1, 2018

(54) AVIONICS SYSTEM FOR CREATING A DATA CLOUD AND FOR INTERACTING WITH THE DATA CLOUD AND ASSOCIATED METHOD

(71) Applicant: THALES, COURBEVOIE (FR)

(72) Inventors: Yannick LE ROUX, SAINT MEDARD EN JALLES (FR); Alexiane BAILLY, MARCHEPRIME (FR); Stéphanie LAFON, MARTIGNAS SUR JALLE (FR); François MICHEL, MERIGNAC (FR)

(21) Appl. No.: 15/684,279

(22) Filed: Aug. 23, 2017

(30) Foreign Application Priority Data
Sep. 1, 2016 (FR) 1601294

(51) Int. Cl. G06F 17/27; G06F 3/023; G06F 3/16; G06F 3/0484; G06F 3/0482

(52) U.S. Cl. CPC G06F 17/278; G06F 3/0233; B64D 43/00; G06F 3/04842; G06F 3/0482; G06F 3/167

(57) ABSTRACT

An avionics system comprises an analysis system for analysing the data input, arranged so as to ensure the following functionalities: recognition of the characteristics of each datum and creation of a raw alphanumeric datum; decomposition of the raw alphanumeric datum into numerical values and into referenced parameters or into unreferenced information or into unutilizable information; verification of the consistency of the information emanating from the raw alphanumeric datum; transformation of the raw alphanumeric datum into utilizable alphanumeric datum; the alphanumeric data being displayed in a data “cloud” on the viewing device, the data being able to be selected, modified or moved by the interaction means.

### CROSS-REFERENCE TO RELATED APPLICATIONS

This application claims priority to foreign French patent application No. FR 1601294, filed on Sep. 1, 2016, the disclosure of which is incorporated by reference in its entirety.

### FIELD OF THE INVENTION

The technical field of the invention is that of avionics systems and more specifically that of devices making it possible to interact with the avionics system in order to input the data used to parametrize avionics systems and equipment.

### BACKGROUND

Currently, data input devices rest upon various principles.

The first of them consists in using an electronic notepad or “scratchpad” integrated into a system of “MCDU” type, the acronym standing for “Multi Function Display Unit”. A physical keyboard makes it possible to input a displayed datum into this “scratchpad”. This datum is thereafter allotted to a field in a specific page of the MCDU. The “scratchpad” allows the data to be entered only one by one.

In more recent aeroplanes that have entered into service in the twenty-first century, interactivity is close to that which exists in current mass-market computerized devices. The ARINC 661 standard specifies this interface between the cockpit viewing sub-system and the other equipment of the aircraft system. The general principle of inputting a datum consists in designating a particular field on a viewing screen with a graphical cursor and then in specifying the new value by means of an alphanumeric keyboard. This principle is antithetical to the notion of scratchpad both in its principle and in the order of the actions. Indeed, in an MCDU, the datum is input and then allotted. In current systems, the datum is allotted before being input.

It should also be recalled that, still today, pilots take hand-written notes, for example when they receive a directive from the air traffic control, to thereafter re-input the data into the dedicated fields or into the MCDU or on the FCU, the acronym standing for “Flight Control Unit”, or on the interactive screens of the instrument panel.

All these solutions have the drawback of being isolated from one another. A datum input on a device cannot easily be transposable to another system.

### SUMMARY OF THE INVENTION

The system according to the invention does not exhibit the previous drawbacks. Its principle consists in setting up a list of manipulatable objects, called a “data cloud”, the said data being virtualized and made secure, allocatable directly to fields that can be edited or modified by the operator. This entails offering a system for inputting parameters by pilots disregarding the origin of the datum input by the user and offering the same service for allocating and using these data in the various systems of the avionics.

More precisely, the subject of the invention is an avionics system for aircraft comprising at least one device for inputting raw data sent by a user, a graphics processor, a viewing device, means of interaction by the said user with the said viewing device, means of control of the parameters of the avionics system, linked to the said viewing device,

Characterized in that the avionics system comprises an analysis system for analysing the raw data input, the said analysis system being arranged so as to ensure the following functionalities for each raw datum:

recognition of the units and fields characteristic of the raw datum and creation of a raw alphanumeric datum representative of the raw datum;

decomposition of the raw alphanumeric datum into numerical values and into referenced associated parameters or into unreferenced information or into unutilizable information;

verification of the consistency of the information emanating from the decomposition of the raw alphanumeric datum;

transformation of the raw alphanumeric datum into utilizable alphanumeric datum;

the said alphanumeric data being displayed in a data “cloud” on the viewing device, the said displayed data being able to be selected, modified or moved by the interaction means so as to interact with the parameters of the avionics system.

Advantageously, the data input device is an alphanumeric keyboard or a voice recognition system or a system for transferring computerized data.

Advantageously, the recognition of the units and fields characteristic of the raw datum is carried out as a function of the general aeronautical context and of the particular situation of the aircraft at the instant at which the raw datum is input.

Advantageously, the verification of the consistency of the information is carried out as a function of the ranges of values of the parameters of the aircraft and of the particular situation of the aircraft at the instant at which the raw datum is input.

Advantageously, the avionics system comprises means for confirming the selection by the means of interaction of a displayed datum of the data cloud.

Advantageously, the selection of a datum brings about the display of a dialogue box or of a multiple-choice menu.

Advantageously, the selection of a datum brings about the display of an alphanumeric keyboard or the triggering of a voice recognition system.

Advantageously, the data of the data cloud are accompanied by an indicator representative of the reliability level of the datum.

The invention also relates to a method for creating a data cloud and for interacting with the said data cloud in an avionics system, the said avionics system comprising at least one device for inputting raw data sent by a user, an analysis system for analysing the raw data input, a graphics processor, a viewing device, means of interaction by the said user with the said viewing device, means of control of the parameters of the avionics system, linked to the said viewing device,

Characterized in that the method comprises the following steps:

recognition of the units and fields characteristic of the raw datum and creation of a raw alphanumeric datum representative of the raw datum;

decomposition of the raw alphanumeric datum into numerical values and into referenced associated parameters or into unreferenced information or into unutilizable information;

verification of the consistency of the information emanating from the decomposition of the raw alphanumeric datum;

transformation of the raw alphanumeric datum into utilizable alphanumeric datum;

display of the said alphanumeric data in a data “cloud” on the viewing device,

selection, modification or movement of the said data displayed by the interaction means so as to interact with the parameters of the avionics system.

### BRIEF DESCRIPTION OF THE DRAWING

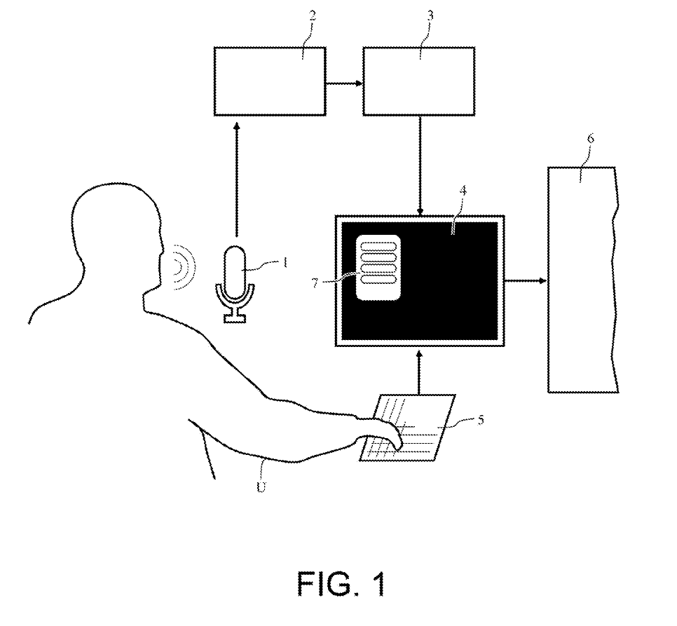

The invention will be better understood and other advantages will become apparent on reading the nonlimiting description which follows and by virtue of the appended FIG. 1 representing the general schematic of the avionics system according to the invention.

### DETAILED DESCRIPTION

As seen in FIG. 1, the avionics system for aircraft according to the invention comprises at least:
a device 1 for inputting raw data sent by a user U,
an analysis system 2 for analysing the raw data input,
a graphics processor 3,
a viewing device 4,
means of interaction 5 by the said user with the said viewing device,
means of control 6 of the parameters of the avionics system, linked to the said viewing device.

The functions of these various devices are detailed hereinbelow.

The device 1 for inputting raw data can be of any type. By way of nonlimiting examples, this device is:
a hand-written note;
an alphanumeric keyboard;
a touch surface;
a gesture recognition device;
a voice recognition device as symbolized in FIG. 1 by a microphone;
a device for audio information emanating, for example, from the air traffic control;
a device for digital highlighting of paper documents;
a device for identifying a datum which has been input into the avionics system or has been proposed by the avionics system;
a device for receiving a datum coming from a system or from an item of equipment external to the avionics.

All these data input are put into alphanumeric form. As a general rule, the data input will be able, by various criteria, to be typed. This offers the definite advantage of limiting the fields and the recipient systems which in general only accommodate data of defined type and of limited domain of definition.

The analysis system 2 for analysing the said raw data carries out the functions detailed hereinbelow.

The first function is the recognition of the units and fields characteristic of the datum.

The second function is the analysis of the alphanumeric datum according to various known aeronautical criteria such as:
Knowledge of known ranges of value of each unit;
Knowledge of the regulatory or standardized structure of the messages exchanged;
Existence of a known grammar, according to the number of characters. This grammar corresponds, for example, to the identifiers of airports, to points of databases, to airport clearances;
Identification of the type of numerical data depending on whether they are decimal or integer;
Knowledge of the situation of the aeroplane and of its flight phase depending on whether dealing with, for example, takeoff, cruising flight or landing;
Contextual knowledge.

The datum output by this analysis is always an alphanumeric datum cut up into:

segments “of values” and “of characteristic units or field” which are typed;

segments of “information” which is untyped but potentially utilizable;

segments of “waste”, that is to say of unutilizable information. The waste disappears in this step.

The third function consists in checking each segment of each so-called “value” datum or so-called “information” datum.

Knowing the list of avionics systems that are potentially clients of each of the typed values, it is a question of making sure of the consistency of each value with the current context of the aircraft. This analysis is based on a certain number of criteria. The most usual are the following:

knowledge of the possible regulatory or standardized structure of the messages exchanged and consistency between the value and this structure;

knowledge of the ranges of values. As a function of the value of the datum depending on whether the latter is decimal, integer or discrete, the latter may be rounded or complete;

knowledge of the units used. It is possible to remove the ambiguity, if any, in respect of the unit of the value as a function of the possible ranges of values. For example, a Flight Level or “FL” datum is an altitude and cannot be allocated to a speed target, but may be allocated to an altitude target or to an altitude constraint. In the same manner, the range of the values of audio frequencies is known and limited. It lies, for example, between 118.000 MHz and 136.000 MHz or 152.950 MHz, thereby making it possible to exclude any frequency value outside of these intervals for the allotting of a frequency;

knowledge of the flight phase of the aeroplane which may be takeoff, landing or cruising flight;

knowledge of the confidence level in respect of the recognition of the characters or the audio signal;

The “value” datum is then transformed into a separate object, with which are associated a digital value and optionally:

a type and a unit, one and the same type being able to have several units,

a confidence and integrity rate with respect to the initial datum,

a list of systems and of parameters of these systems which can literally take the value borne by the object.

The uncharacterized “information” is no less potentially interesting. It is transformed into objects and may optionally be corrected, or supplemented or typed by the user himself, in the data cloud. In this case, “the information” is transformed into “value”.

In this step a phase of “securing” must make it possible to contrive matters so that an object, whether a value or item of information, can in no case impair the stability or the robustness of an avionics system.

Once these various functions have been carried out, the analysis system transmits the analysed data to the graphics processor 3. The latter displays these data in the form of a data cloud 7 on a viewing device 4 of the instrument panel. This cloud has the advantage of enabling several data to be input on the fly as they arrive, so as subsequently to enable them to be allocated directly, without a second step of inputting into the dedicated fields, thereby representing for the operator an appreciable gain in performance and storage, as well as a noticeable reduction in the number of errors of input.

Various possible presentations of this data cloud exist. The organization of the data in the cloud can be done by date of input or by type of information or else by type of initial source. The presentation of the data can be done in various ways. In FIG. 1, by way of nonlimiting example, the data are presented in a column of cartouches.

The operator U can manipulate the data present in the data cloud by means of various interaction devices 5. By way of nonlimiting examples, mention will be made of the use of a keyboard as represented in FIG. 1, of a touchscreen, of a touch surface, of a voice control, etc. The data can be selected, modified or deleted. An object present in the data cloud may thus:

Be selected and automatically allocated by control means 6 to a parameter of an avionics system. The allocation of the value of the object to a parameter is done by considering both its value and also the unit of the object. A confirmation step is then necessary to guarantee the consistency of the action. When it is allocated, an object may either disappear from the cloud or persist for another use;

Be input and brought to a “target” zone representing a modifiable parameter of an avionics system. A confirmation step may optionally be necessary;

Be selected and amended, by a correction, an addition of data, a selection of units chosen from a determined list. It is also possible to correct an incorrect or manifestly inaccurate datum. This possibility is illustrated by the examples hereinbelow.

Be deleted from the cloud.

By way of first example of amending an object, during a takeoff phase, the user enters the value “14” with no other particulars. This object “14” appears in the data cloud. On selection, three possible units are proposed: they are: “angular degrees”, “knots” and “thermal degrees”. With the first unit is associated the orientation of the heading or the heading itself, with the second unit is associated the speed of the wind and with the third unit are associated the exterior temperature and the dew point temperature. The user then chooses the appropriate unit.

By way of second example, in the takeoff phase, the pilot inputs the value “140”. A new object bearing the information “140” is created and made available in the data cloud. On selection, four possible units are proposed. They are: “Flight level”, “angular degrees”, “knots” and “upward speed unit”. With the first unit is associated the target altitude or the cruising altitude, with the second unit is associated the orientation of the wind or the heading, with the third unit are associated the speed of the wind or the requested speed and with the fourth unit is associated the climb speed. The user then chooses the appropriate unit.

Moreover, the data cloud can advantageously serve as selection zone for:

launching a verbalization for voice recognition,

opening a keyboard and inputting a datum via this keyboard,

launching a phase of writing on the fly on the screen, followed by a writing recognition.

The data cloud is also compatible with the ARINC 661 standard which specifies that the modification of a datum of the avionics begins with the selection of an appropriate field. In the context offered by the invention, the data cloud can be used to designate a value for this field directly while editing.

In the case of certain text input techniques, it may be extremely beneficial to mark the text with a confidence level as regards the recognition of words in the initial signal, be it a gesture, an image, a digital or analogue audio signal, a gesture or visual sweep. This confidence level makes it possible inter alia to characterize whether the object is usable as is, whether it must be corrected or eliminated. This confidence level is determined according to various criteria, as a function of recognition principles and algorithms.

1. An avionics system for aircraft comprising at least one device for inputting raw data sent by a user, a graphics processor, a viewing device, means of interaction by the said user with the said viewing device, means of control of the parameters of the avionics system, linked to the said viewing device,
wherein the avionics system comprises an analysis system for analysing the raw data input, the said analysis system being arranged so as to ensure the following functionalities for each raw datum:
recognition of the units and fields characteristic of the raw datum and creation of a raw alphanumeric datum representative of the raw datum;
decomposition of the raw alphanumeric datum into numerical values and into referenced associated parameters or into unreferenced information or into unutilizable information;
verification of the consistency of the information emanating from the decomposition of the raw alphanumeric datum;
transformation of the raw alphanumeric datum into utilizable alphanumeric datum, with which is associated a digital value and:
a type and/or a unit;
and/or a confidence and integrity rate with respect to the initial datum;
and/or a list of systems and of parameters of these systems liable to take the value borne by the object;
the said alphanumeric data being displayed in a data “cloud” on the viewing device, the said displayed data being able to be selected, modified or moved by the interaction means so as to modify or allocate the parameters of the avionics system.

2. The avionics system according to claim 1, wherein the data input device is an alphanumeric keyboard or a voice recognition system or a system for transferring computerized data.

3. The avionics system according to claim 1, wherein the recognition of the units and fields characteristic of the raw datum is carried out as a function of the general aeronautical context and of the particular situation of the aircraft at the instant at which the raw datum is input.

4. The avionics system according to claim 1, wherein the verification of the consistency of the information is carried out as a function of the ranges of values of the parameters of the aircraft and of the particular situation of the aircraft at the instant at which the raw datum is input.

5. The avionics system according to claim 1, wherein the avionics system comprises means for confirming the selection by the means of interaction of a displayed datum of the data cloud.

6. The avionics system according to claim 1, wherein the selection of a datum brings about the display of a dialogue box or of a multiple-choice menu.

7. The avionics system according to claim 1, wherein the selection of a datum brings about the display of an alphanumeric keyboard or the triggering of a voice recognition system.

8. The avionics system according to claim 1, wherein the data of the data cloud are accompanied by an indicator representative of the reliability level of the datum.

9. A method for creating a data cloud and for interacting with the said data cloud in an avionics system, the said avionics system comprising at least one device for inputting raw data sent by a user, an analysis system for analysing the raw data input, a graphics processor, a viewing device, means of interaction by the said user with the said viewing device, means of control of the parameters of the avionics system, linked to the said viewing device,
wherein the method comprises the following steps:
recognition of the units and fields characteristic of the raw datum and creation of a raw alphanumeric datum representative of the raw datum;
decomposition of the raw alphanumeric datum into numerical values and into referenced associated parameters or into unreferenced information or into unutilizable information;
verification of the consistency of the information emanating from the decomposition of the raw alphanumeric datum;
transformation of the raw alphanumeric datum into utilizable alphanumeric datum with which is associated a digital value and:
a type and/or a unit;
and/or a confidence and integrity rate with respect to the initial datum;
and/or a list of systems and of parameters of these systems liable to take the value borne by the object;
display of the said alphanumeric data in a data “cloud” on the viewing device,
selection, modification or movement of the said data displayed by the interaction means so as to modify or allocate the parameters of the avionics system.
